(19) United States
(12) Patent Application Publication
(10) Pub. No.: US 2023/0144647 A1
(43) Pub. Date: May 11, 2023

(54) METHOD FOR MAKING CANDIES

(71) Applicant: BONCHA BONCHA INTERNATIONAL COMPANY LIMITED, Taipei (TW)

(72) Inventor: Ming-Jie Tsai, TAIPEI (TW)

(21) Appl. No.: 17/977,829

(22) Filed: Oct. 31, 2022

(30) Foreign Application Priority Data
Nov. 5, 2021 (TW) 110141350

(51) Int. Cl. A23G 3/34; A23G 3/42; A23G 3/40; A23G 3/44; A23L 33/135

(52) U.S. Cl. CPC A23G 3/0014; A23G 3/0048; A23G 3/42; A23G 3/40; A23G 3/44; A23L 33/135

(57) ABSTRACT

A method for making candies comprises steps of: a) providing oil, sugar, syrup, emulsifier, protein powder and hydrated colloid; b) evenly stirring the materials in a deoxygenated environment with a pressure of 10˜50 mmHg and a temperature of 115˜125° C. to form a stuffing; c) cooling the stuffing to 24˜26° C. under a relative humidity of 10˜15% and a pressure of 10˜50 mmHg; d) increasing the pressure of the stuffing to 370˜390 mmHg, adding dormant probiotic powder into the stuffing, and evenly mixing the stuffing to form a sugar core; e) increasing to atmospheric pressure for the sugar core; f) in the absence of air, encapsulating the sugar core with a encapsulating sugar mass at a temperature of 50˜60° C. to form a probiotic sugar bar; and g) stretching the probiotic sugar bar, and then cooling down the temperature to 18-22° C. within 5 seconds and cutting the probiotic sugar bar to form candies.

### FIELD OF THE INVENTION

The present invention relates to a method for making candies. More particularly, the present invention relates to a method for making probiotics or fish oil candies.

### BACKGROUND OF THE INVENTION

Probiotics refer to the ingestible microorganisms, such as Bifidobacterium bifidum, Lactobacillus, Bifidobacterium longum, etc., that have positive benefits to the host after entering the body of the host (such as human) through the esophagus. According to different strains, probiotics have the beneficial functions of adjusting the microbiota of the digestive tract, strengthening physique, maintaining digestive tract function, lowering blood oil, reducing the risk of colorectal cancer risk, etc. To increase or supplement the amount of probiotics in the body, many people swallow probiotic preparations. Since most probiotics live in the gut, they may be destroyed in the digestive tract before reaching the gut, e.g., hurt by stomach acid in the stomach. Therefore, Manufacturers of various probiotic preparations have their own capsulation technology with special structures to ensure that most probiotics can reach the intestinal tract smoothly. Since the life cycle of probiotics is measured in hours, probiotics are in a dormant state in the preparation, so that the probiotics can be activated when they reach their destination and complete the functions of their limited life. These capsulation technologies not only consider the protection of probiotics, but also prevent the activation of probiotics. Generally speaking, dormant probiotics will be activated when they encounter water and oxygen and stop dormancy and become active. Therefore, the aforementioned capsulation techniques must ensure that the probiotics are isolated from the moisture in the environment.

In practice, water activity (Aw) is an indicator used to measure whether the environment in which the probiotics are activated. Water activity refers to the ratio of the saturated vapor pressure of a food to the saturated vapor pressure of pure water at the same temperature in a confined space. When probiotics are encapsulated in powder packets, the water activity in the environment is quite low, usually maintained below 0.25, and most probiotics will remain in a dormant state. If probiotics are mixed into other ingredients to make composite foods, such as candy containing probiotics, the environment in which probiotics are placed in the composite foods is difficult to maintain low water activity for a long time. As a result, these composite foods end up with far less beneficial bacteria than expected for people to eat. On the other hand, oxygen concentration is another important indicator used to measure whether the environment allows probiotics to live. When oxygen concentration is lower than 10% volume concentration, most probiotics will remain in a dormant state. The same demand is happening for candies wrapping fish oil.

Therefore, in the case of candy, if probiotics or fish oil are to be added to form a composite food, a special process is necessary to ensure low water activity and low oxygen concentration in the candy structure. Therefore, a method for making candies of the present invention is proposed.

### SUMMARY OF THE INVENTION

This paragraph extracts and compiles some features of the present invention; other features will be disclosed in the follow-up paragraphs. It is intended to cover various modifications and similar arrangements included within the spirit and scope of the appended claims.

In order to meet the aforementioned requirements, a method for making candies is provided in the present invention. The method comprises steps of: a) providing 15˜40 parts by weight of oil, 20˜70 parts by weight of sugar, 2˜25 parts by weight of syrup, 0.1˜0.6 parts by weight of emulsifier, 10˜25 parts by weight of protein powder and 0.2˜4.5 parts by weight of hydrated colloid; b) evenly stirring the aforementioned materials in a deoxygenated environment with a pressure of 10˜50 mmHg and a temperature of 115˜125° C. to form a stuffing; c) cooling the stuffing to 24˜26° C. under a relative humidity of 10˜15% and a pressure of 10˜50 mmHg; d) increasing the pressure of the stuffing to 370˜390 mmHg, adding dormant probiotic powder into the stuffing, and evenly mixing the stuffing to form a sugar core; e) increasing the pressure of the environment of the sugar core to atmospheric pressure with temperature maintained at 24˜26° C.; f) in the absence of air, encapsulating the sugar core with a encapsulating sugar mass at a temperature of 50˜60° C. to form a probiotic sugar bar; and g) stretching the probiotic sugar bar to become thinner, and then cooling down the temperature to 18-22° C. within 5 seconds and cutting the probiotic sugar bar to form a plurality of separated candies.

According to the present invention, the deoxygenated environment in the step b) is to fill a small amount of nitrogen to maintain the pressure of 10˜50 mmHg in the environment for stirring the stuffing.

Another method for making candies is also provided in the present invention. The method comprises steps of: a) providing 15˜40 parts by weight of oil, 20˜70 parts by weight of sugar, 2˜25 parts by weight of syrup, 0.1˜0.6 parts by weight of emulsifier, 10˜25 parts by weight of protein powder and 0.2˜4.5 parts by weight of hydrated colloid; b) evenly stirring the aforementioned materials in a deoxygenated environment with a pressure of 10˜50 mmHg and a temperature of 115˜125° C. to form a stuffing; c) cooling the stuffing to 24˜26° C. under a relative humidity of 10˜15% and a pressure of 10˜50 mmHg; d) increasing the pressure of the stuffing to 100˜150 mmHg, adding fish oil into the stuffing, and evenly mixing the stuffing to form a sugar core; e) increasing the pressure of the environment of the sugar core to atmospheric pressure with temperature maintained at 24˜26° C.; f) in the absence of air, encapsulating the sugar core with a encapsulating sugar mass at a temperature of 50˜60° C. to form a fish oil sugar bar; and g) stretching the fish oil sugar bar to become thinner, and then cooling down the temperature to 18-22° C. within 5 seconds and cutting the fish oil sugar bar to form a plurality of separated candies.

Preferably, oil may be palm oil, sesame oil, olive oil, sacha inchi oil, linseed oil, coconut oil, camellia oil, soybean oil, brown rice oil, canola oil, perilla oil, sunflower oil, peanut oil, or a combination of the foregoing.

Preferably, syrup may be corn syrup, maltitol syrup, starch syrup or oligosaccharide syrup.

Preferably, emulsifier may be lecithin, acacia gum, sanxian gum, flower wax or beeswax.

Preferably, protein powder may be whey protein powder or soy protein powder.

Preferably, hydrated colloid may be gelatin, agar, carrageenan or pectin.

Preferably, the time for the sugar core to be encapsulated and cooled down is no more than 5 minutes.

According to the present invention, the outer encapsulating sugar mass of the separated candies completely encapsulates the inner sugar core.

According to the present invention, increasing the pressure of the environment in the step e) is adding an appropriate amount of air or nitrogen to the environment where the sugar core is located.

The present invention can ensure low water activity and low oxygen concentration of the candies by controlling the temperature, pressure and relative humidity in the process, and solve the problems faced in the current production of candies.

### BRIEF DESCRIPTION OF THE DRAWINGS

FIG. 1 is a flow chart of a method for making candies according to the present invention.

FIG. 2 is a part of equipment used in the method for making candies.

FIG. 3 is another part of equipment used in the method for making candies.

FIG. 4 is a sectional view of candy made according to the method for making candies.

FIG. 5 lists candies with different contents made according to the method for making candies.

FIG. 6 is a graph showing the changes in the number of live probiotics in candies with different contents over time.

### DETAILED DESCRIPTION OF THE PREFERRED EMBODIMENTS

The present invention will now be described more specifically with reference to the following embodiments.

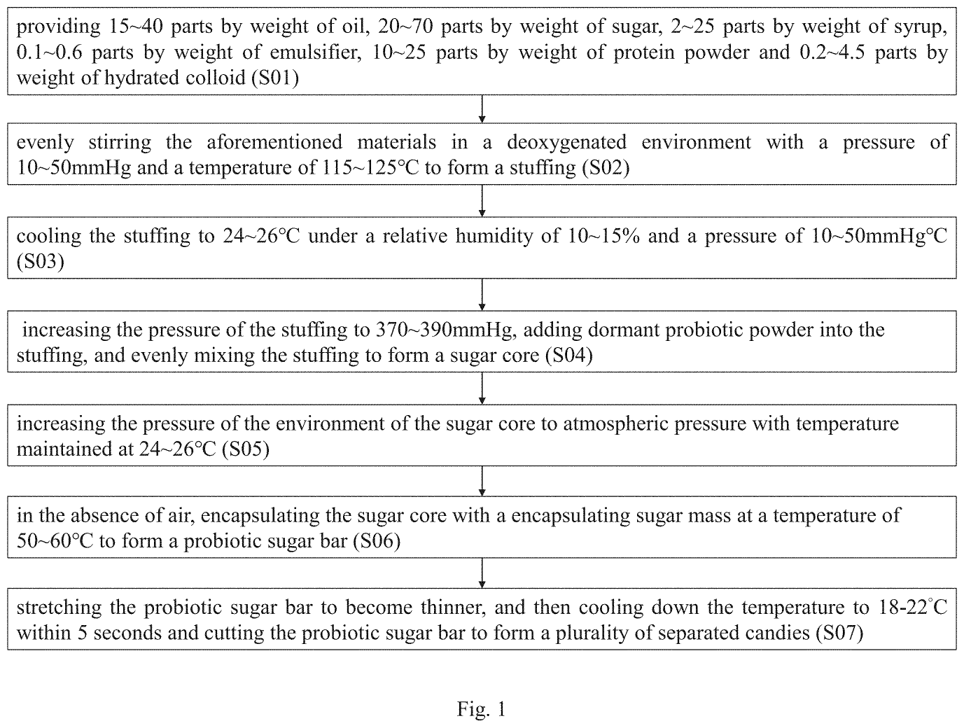

Refer to FIG. 1. It is a flow chart of a method for making candies (hereinafter referred to as the method) according to the present invention. A first step of the method is providing 15˜40 parts by weight of oil, 20˜70 parts by weight of sugar, 2˜25 parts by weight of syrup, 0.1˜0.6 parts by weight of emulsifier, 10˜25 parts by weight of protein powder and 0.2˜4.5 parts by weight of hydrated colloid (S01). These materials are used to make the stuffing for encapsulating probiotic powder.

In the embodiment provided in the description, oil used is palm oil. According to the present invention, in addition to palm oil, the materials that can be used for the oil are sesame oil, olive oil, sacha inchi oil, linseed oil, coconut oil, camellia oil, soybean oil, brown rice oil, canola oil, perilla oil, sunflower oil, peanut oil, and a combination of the foregoing. Syrup may be corn syrup, maltitol syrup, starch syrup or oligosaccharide syrup. Maltitol syrup is used in the embodiment. The purpose of adding liquid syrup to the solid sugar is to let the syrup to provide the fluidity required for mixing the stuffing and to inhibit crystallization of solid sugar during storage. The emulsifier used in the present invention may be, but is not limited to lecithin, acacia gum, sanxian gum, flower wax or beeswax. Lecithin is used in the embodiment. Protein powder may be whey protein powder or soy protein powder. Whey protein powder is used in the embodiment. Hydrated colloid may be gelatin, agar, carrageenan or pectin. The embodiment is illustrated using carrageenan.

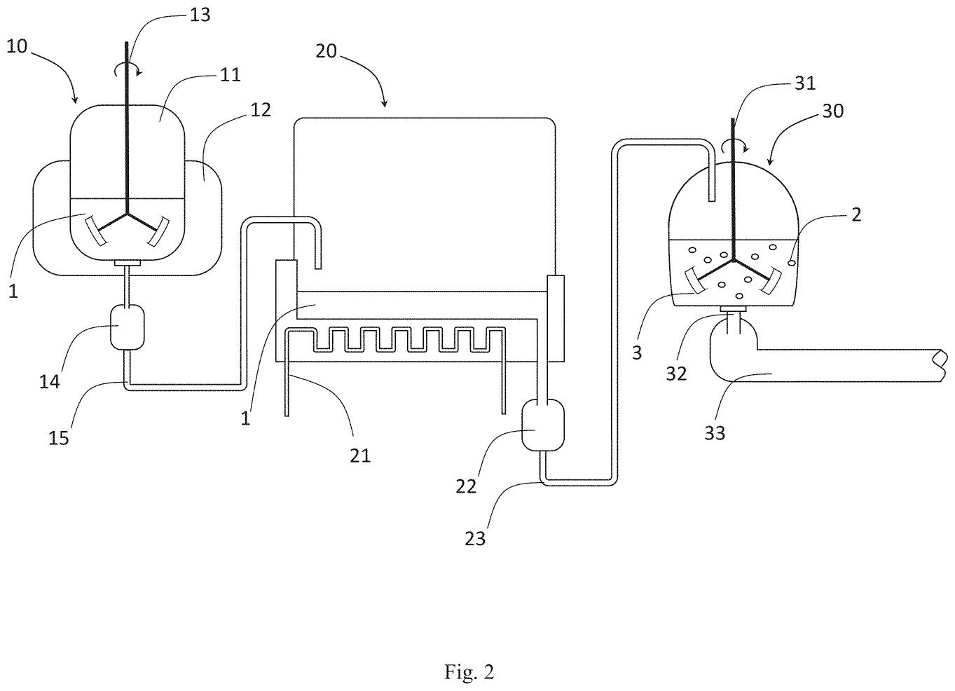

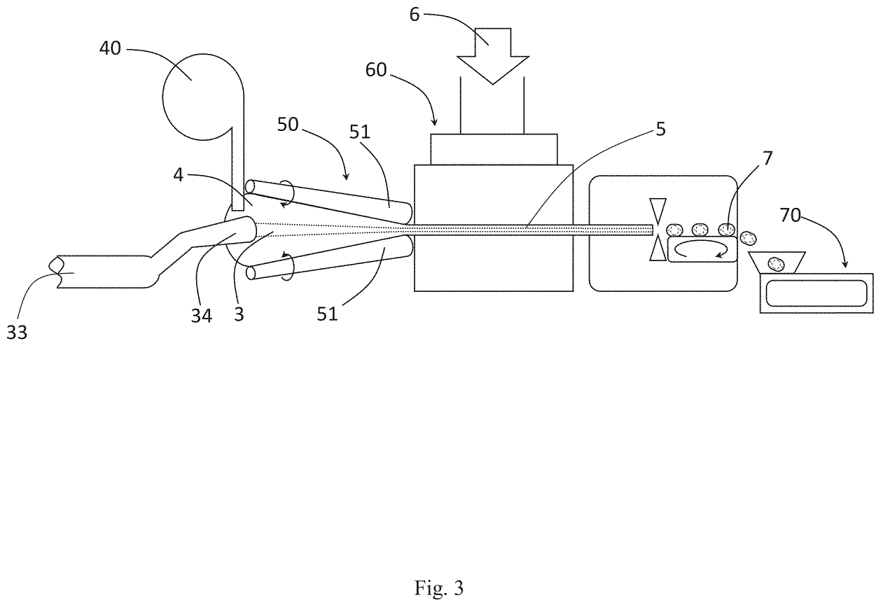

A second step of the method is evenly stirring the aforementioned materials in a deoxygenated environment with a pressure of 10˜50 mmHg and a temperature of 115˜125° C. to form a stuffing (S02). In order to complete step S02, some specific equipment and related operation methods need to be used. For this, including the equipment used in this and the following steps, see FIG. 2 and FIG. 3. The two figures respectively show some of the equipment used in the method. As shown in FIG. 2, a vacuum cooker 10 is used to perform step S02. The vacuum cooker 10 can adjust the pressure in its pot 11 from less than atmospheric pressure to near-vacuum state. The pot 11 contains the aforementioned ingredients for mixing and making stuffing 1. These materials are heated to 115-125° C. by the heating equipment 12 of the vacuum cooker 10, for example, by applying steam to the surface of the pot 11. The deoxygenated environment in this step is to fill a small amount of nitrogen to maintain the pressure of 10˜50 mmHg in the environment (pot 11) for stirring the stuffing. In the aforementioned environment, the stirring rod 13 is continuously rotated so that the stuffing 1 is evenly formed.

Next, a third step of the method is cooling the stuffing to 24˜26° C. under a relative humidity of 10˜15% and a pressure of 10˜50 mmHg (S03). In order to achieve this, the production equipment for the stuffing 1 has to be changed. As shown in FIG. 2, the finished stuffing 1 passes through a pressure valve 14 and flows along a pressure tube 15 to a dehumidifier and cooling machine 20 with an internal pressure approximately equal to 10˜50 mmHg. The stuffing 1 in the dehumidifier and cooling machine 20 is affected by the cooling equipment 21, such as a condensed water circulation device. Temperature gradually decreases from the original 115˜125° C. to 24˜26° C. It should be noticed that since the water in the stuffing 1 will gradually evaporate into the dehumidifier and cooling machine 20, in addition to the relative humidity control, the dehumidifier and cooling machine 20 must also simultaneously control the pressurization caused by the evaporated water.

After step S03, a fourth step of the method is increasing the pressure of the stuffing to 370˜390 mmHg, adding dormant probiotic powder into the stuffing, and evenly mixing the stuffing to form a sugar core (S04). In order to achieve this goal, the stuffing 1 also needs to change the production equipment. As shown in FIG. 2, after the stuffing 1 in the dehumidifier and cooling machine 20 is boosted to 370˜390 mmHg through a boost valve 22, it flows into a vacuum mixer 30 through a pressure tube 23. Add probiotic powder 2 in dormant state into the stuffing 1 in vacuum mixer 30, and mix them evenly with a stirring rod 31 to form a sugar core 3. The sugar core 3 is a thick liquid, and its state is related to the amount of probiotic powder 2. According to the spirit of the present invention, the amount of probiotic powder 2 used is not limited, as long as the number of live probiotics in probiotic powder 2 can be maintained within the product requirements.

Next, a fifth step of the method is increasing the pressure of the environment of the sugar core to atmospheric pressure with temperature maintained at 24˜26° C. (S05). See FIG. 2 and FIG. 3. After the sugar core 3 has formed, it passes a booster valve 32 and is boosted up to atmospheric pressure (around 760 mmHg), flowing to a connecting pipe 33. The principle of pressurizing to atmospheric pressure in this step is to add an appropriate amount of air or nitrogen to the environment where the sugar core 3 is located (booster valve 32). The gas will fill into the sugar core 3 but will not significantly increase the water activity and oxygen concentration of the sugar core 3.

A sixth step of the method is in the absence of air, encapsulating the sugar core with an encapsulating sugar mass at a temperature of 50˜60° C. to form a probiotic sugar bar (S06). Please see FIG. 3. The end of the connecting pipe 33 is connected with an extrusion device 34. The extrusion device 34 can extrude the sugar core 3 in the connecting pipe 33 (the extruded sugar core 3 is shown by a dotted line). Meanwhile, a filling machine 40 keeps providing encapsulating sugar mass 4 to encapsulate the extruded sugar core 3. Since the sugar core 3 is encapsulated by the encapsulating sugar mass 4 to form the probiotic sugar bar 5, the sugar core 3 is isolated from outside air.

Last, a seventh step of the method is stretching the probiotic sugar bar to become thinner, and then cooling down the temperature to 18-22° C. within 5 seconds and cutting the probiotic sugar bar to form a plurality of separated candies (S07. It can be seen from FIG. 3 that the probiotic sugar bar 5 is thicker near the extrusion device 34 and is elongated and thinned by a stretching device 50. The stretching device 50 comprises a pair of stretch tubes 51 with different diameters at both ends and a gradually changing body. The stretch tubes 51 rotate in different directions from each other. The probiotic sugar bar 5 passes between the stretch tubes 51, is stretched by the rotation of the stretch tubes 51, and is limited by the shape of the stretch tubes 51. The probiotic sugar bar 5 can also be thinner evenly with the stretch tubes 51. The probiotic sugar bar 5 at the end of the stretching device 50 is sent to a cooling cutting and forming machine 60 for cutting. A cooling cutting and forming machine 60 can cut and form while rapidly cooling the probiotic sugar bar 5, e.g., by liquid nitrogen 6.

Since the temperature of the encapsulating sugar mass 4 is 50˜60° C., this temperature is easy to kill the probiotics in the dormant state. The actual state is that with the increase of the encapsulating time, the extruded sugar core 3 will start to heat from the outside to the center. The number of living probiotics also decreases from the outside to the center. To reduce the number of dead probiotics, the probiotic sugar bar 5 is refrigerated quickly when cutting. Preferably, the time for the sugar core 3 to be encapsulated by the encapsulating sugar mass 4 be and cooled down is no more than 5 minutes.

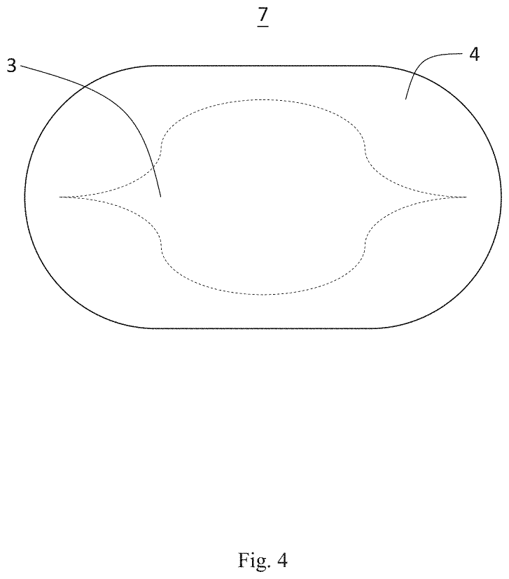

See FIG. 4. It is a sectional view of a candy 7 made according to the method for making candies. One of the features of the present invention is that the outer encapsulating sugar mass 4 of the separated candy 7 completely encapsulates the inner sugar core 3 to ensure that the probiotics in the sugar core 3 will be in an environment with low water activity and low oxygen concentration. To achieve such results, the encapsulating sugar mass 4 must maintain a certain elasticity during cutting; that is, the temperature should not be too low (about 40 degrees). After the probiotic sugar bar 5 is cut, the encapsulating sugar mass 4 on the cutting surface (the two sides of FIG. 4 near arc shape) will quickly converge to the center of the cutting surface due to the stretch elasticity during separation, so that the cut section of the sugar core 3 is covered, and the state shown in FIG. 4 is formed.

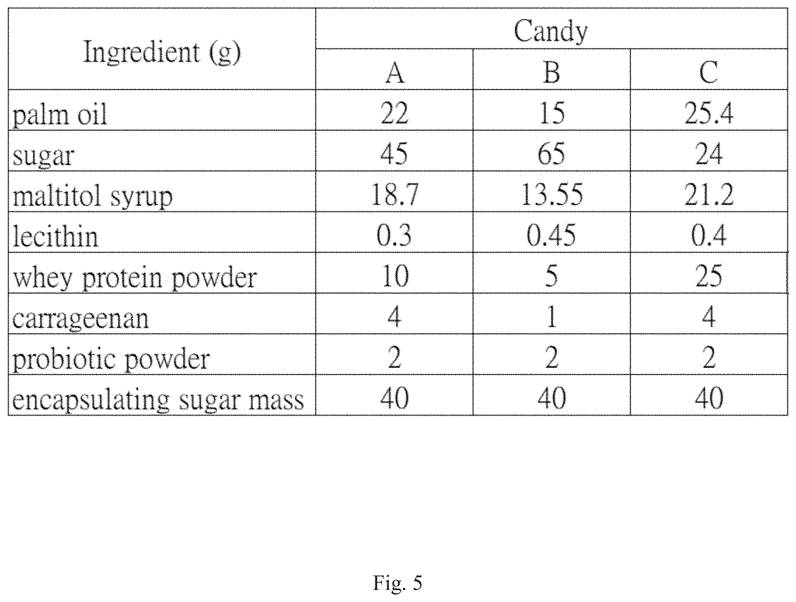

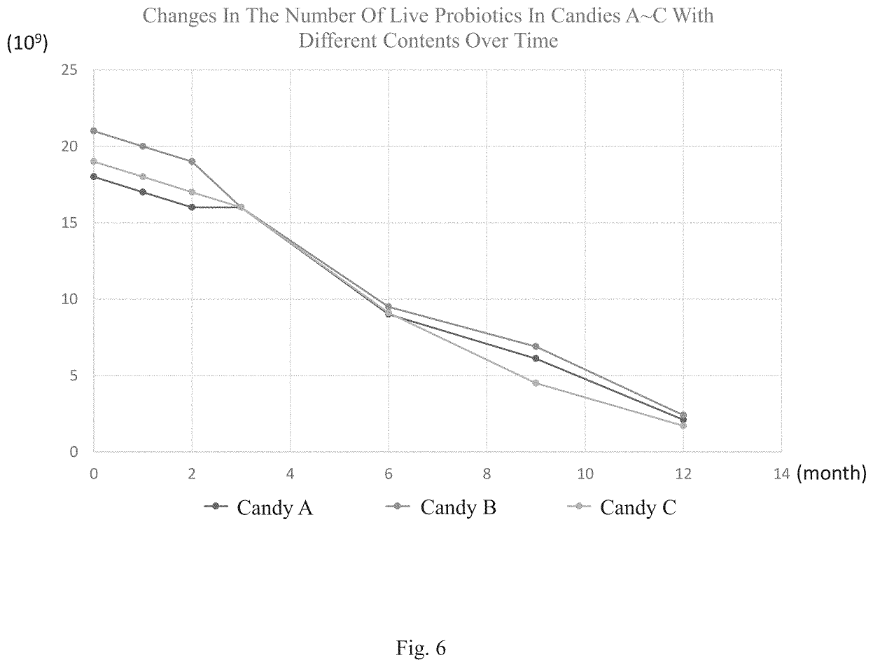

Refer to FIG. 5 and FIG. 6, FIG. 5 lists candies A˜C with different contents made according to the method. FIG. 6 is a graph showing the changes in the number of live probiotics in candies A˜C with different contents over time. In the present embodiment, candy A uses 22 g palm oil, 45 g sugar, 18.7 g maltitol syrup, 0.3 g lecithin, 10 g whey protein powder and 4 g carrageenan to make the stuffing. 2 g of probiotic powder and 40 g of encapsulating sugar mass are used. Candy B uses 15 g palm oil, 65 g sugar, 13.55 g maltitol syrup, 0.45 g lecithin, 5 g whey protein powder and 1 g carrageenan to make stuffing. 2 g of probiotic powder and 40 g of encapsulating sugar mass are used. Candy C uses 25.4 g palm oil, 24 g sugar, 21.2 g maltitol syrup, 0.4 g lecithin, 25 g whey protein powder and 4 g carrageenan to make stuffing. 2 g of probiotic powder and 40 g of encapsulating sugar mass are used. After a year of observation, the number of live probiotics in candies A˜C has decreased, which can meet the requirements of the industry.

According to the spirit of the present invention, the same method can also be applied to candies wrapping fish oil as a base of the stuffing. Compared with the previous embodiment, to make the aforementioned candies, it is only to modify the step S04 as: increasing the pressure of the stuffing to 100˜150 mmHg, mixing fish oil into the stuffing, and evenly mixing the stuffing to form a sugar core. Correspondingly, probiotic sugar bar became fish oil sugar bar. The preservation of fish oil in the candy is also not affected by water activity and oxygen.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A method for making candies, comprising steps of:
a) providing 15˜40 parts by weight of oil, 20˜70 parts by weight of sugar, 2˜25 parts by weight of syrup, 0.1˜0.6 parts by weight of emulsifier, 10˜25 parts by weight of protein powder and 0.2˜4.5 parts by weight of hydrated colloid;
b) evenly stirring the aforementioned materials in a deoxygenated environment with a pressure of 10˜50 mmHg and a temperature of 115˜125° C. to form a stuffing;
c) cooling the stuffing to 24˜26° C. under a relative humidity of 10˜15% and a pressure of 10˜50 mmHg;
d) increasing the pressure of the stuffing to 370˜390 mmHg, adding dormant probiotic powder into the stuffing, and evenly mixing the stuffing to form a sugar core;
e) increasing the pressure of the environment of the sugar core to atmospheric pressure with temperature maintained at 24˜26° C.;
f) in the absence of air, encapsulating the sugar core with a encapsulating sugar mass at a temperature of 50˜60° C. to form a probiotic sugar bar; and
g) stretching the probiotic sugar bar to become thinner, and then cooling down the temperature to 18-22° C. within 5 seconds and cutting the probiotic sugar bar to form a plurality of separated candies.

2. The method for making candies according to claim 1, wherein the deoxygenated environment in the step b) is to fill a small amount of nitrogen to maintain the pressure of 10˜50 mmHg in the environment for stirring the stuffing.

3. The method for making candies according to claim 1, wherein oil is palm oil, sesame oil, olive oil, sacha inchi oil, linseed oil, coconut oil, camellia oil, soybean oil, brown rice oil, canola oil, perilla oil, sunflower oil, peanut oil, or a combination of the foregoing.

4. The method for making candies according to claim 1, wherein syrup is corn syrup, maltitol syrup, starch syrup or oligosaccharide syrup.

5. The method for making candies according to claim 1, wherein emulsifier is lecithin, acacia gum, sanxian gum, flower wax or beeswax.

6. The method for making candies according to claim 1, wherein protein powder is whey protein powder or soy protein powder.

7. The method for making candies according to claim 1, wherein hydrated colloid is gelatin, agar, carrageenan or pectin.

8. The method for making candies according to claim 1, wherein the time for the sugar core to be encapsulated and cooled down is no more than 5 minutes.

9. The method for making candies according to claim 1, wherein the outer encapsulating sugar mass of the separated candies completely encapsulates the inner sugar core.

10. The method for making candies according to claim 1, wherein increasing the pressure of the environment in the step e) is adding an appropriate amount of air or nitrogen to the environment where the sugar core is located.

11. A method for making candies, comprising steps of:
a) providing 15˜40 parts by weight of oil, 20˜70 parts by weight of sugar, 2˜25 parts by weight of syrup, 0.1˜0.6 parts by weight of emulsifier, 10˜25 parts by weight of protein powder and 0.2˜4.5 parts by weight of hydrated colloid;
b) evenly stirring the aforementioned materials in a deoxygenated environment with a pressure of 10˜50 mmHg and a temperature of 115˜125° C. to form a stuffing;
c) cooling the stuffing to 24˜26° C. under a relative humidity of 10˜15% and a pressure of 10˜50 mmHg;
d) increasing the pressure of the stuffing to 100˜150 mmHg, adding fish oil into the stuffing, and evenly mixing the stuffing to form a sugar core;
e) increasing the pressure of the environment of the sugar core to atmospheric pressure with temperature maintained at 24˜26° C.;
f) in the absence of air, encapsulating the sugar core with an encapsulating sugar mass at a temperature of 50˜60° C. to form a fish oil sugar bar; and
g) stretching the fish oil sugar bar to become thinner, and then cooling down the temperature to 18-22° C. within 5 seconds and cutting the fish oil sugar bar to form a plurality of separated candies.

12. The method for making candies according to claim 11, wherein the deoxygenated environment in the step b) is to fill a small amount of nitrogen to maintain the pressure of 10˜50 mmHg in the environment for stirring the stuffing.

13. The method for making candies according to claim 11, wherein oil is palm oil, sesame oil, olive oil, sacha inchi oil, linseed oil, coconut oil, camellia oil, soybean oil, brown rice oil, canola oil, perilla oil, sunflower oil, peanut oil, or a combination of the foregoing.

14. The method for making candies according to claim 11, wherein syrup is corn syrup, maltitol syrup, starch syrup or oligosaccharide syrup.

15. The method for making candies according to claim 11, wherein emulsifier is lecithin, acacia gum, sanxian gum, flower wax or beeswax.

16. The method for making candies according to claim 11, wherein protein powder is whey protein powder or soy protein powder.

17. The method for making candies according to claim 11, wherein hydrated colloid is gelatin, agar, carrageenan or pectin.

18. The method for making candies according to claim 11, wherein the time for the sugar core to be encapsulated and cooled down is no more than 5 minutes.

19. The method for making candies according to claim 11, wherein the outer encapsulating sugar mass of the separated candies completely encapsulates the inner sugar core.

20. The method for making candies according to claim 11, wherein increasing the pressure of the environment in the step e) is adding an appropriate amount of air or nitrogen to the environment where the sugar core is located.
